(19) United States
(12) Patent Application Publication
(10) Pub. No.: US 2022/0198409 A1
(43) Pub. Date: Jun. 23, 2022

(54) METHODS AND SYSTEMS FOR INTERACTIVE DATA MANAGEMENT

(71) Applicant: MARKETSPRINGPAD IP USA LLC., Laredo, TX (US)

(72) Inventor: Kerim Richard Derhalli, London (GB)

(21) Appl. No.: 17/129,608

(22) Filed: Dec. 21, 2020

(51) Int. Cl. G06Q 20/06; G06Q 50/00; A63F 13/792

(52) U.S. Cl. CPC G06Q 20/065; A63F 13/792; G06Q 50/01

(57) ABSTRACT

The described technologies can be used a computer implemented method of cloud data computing with computer readable instructions. The processor(s) may be configured to electronically generating a user digital score attribute data associated with the at least one of the user attribute data. The processor(s) may be configured to electronically generating a graphical user interface for displaying an instrument digital score attribute data including gaming interaction data associated with the computer readable set of user attribute data. The processor(s) may be configured to electronically generating a graphical user interface for displaying a virtual portfolio attribute data associated with the user digital score attribute data and instrument digital score attribute data.

### FIELD OF THE DISCLOSURE

The present disclosure relates to methods, systems, and computing platforms for data interactive management in the cloud computing environment.

### BACKGROUND

The age of Big Data is upon us. In the internet-of-things era, many digital products can be connected to the internet. Online gaming can be provided over computer networks. The world contains a vast amount of digital information which is getting ever vaster more rapidly. The effect is being felt everywhere, from business to science, from governments to the arts. Enterprise organizations utilize various computing infrastructure to make decisions and trigger actions. The computing infrastructure may include computer servers, computer networks, and sensors. Such an environment may include the Internet of Things (IoT). Often time, an IoT environment generates a plethora of raw data that can overwhelm an enterprise organization. As the digital economy continues to develop, cyber data has become a formidable task in the internet-of-things era. There is a need to improve the technological processing in the new computing era.

### SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Aspects of the present disclosure may relate to a system and method configured for data processing that aggregates one or more of customized content for virtual objects functionality, virtualization functionality, social functionality, content management functionality and asset order execution functionality. The system and method are supported by multiple components, such as engines or modules.

In some implementations, the described technologies can be used a computer implemented method of cloud data computing with computer readable instructions. The processor(s) may be configured to electronically processing a computer readable set of user attribute data. The processor(s) may be configured to electronically receiving at least one of the user attribute data. The processor(s) may be configured to electronically generating a user digital score attribute data associated with the at least one of the user attribute data. The processor(s) may be configured to electronically generating a graphical user interface for displaying an instrument digital score attribute data including gaming interaction data associated with the computer readable set of user attribute data. The processor(s) may be configured to electronically generating a graphical user interface for displaying a virtual portfolio attribute data associated with the user digital score attribute data and instrument digital score attribute data.

In some implementations, the described technologies can enable payment and/or e-commerce capabilities in various situations, crypto records of stored value, including blockchain technology.

Aspects of the present disclosure relate to a system and method that provides a rich big data user experience on a technology platform environment. Aspects of the present disclosure relate to a system and method that provides rich big data sets derived from the user experience.

In some implementations of the system and method, a virtualization engine provides trading activity within a portfolio management module. The virtualization engine may provide real-time mark-to-market from database of user account trades and portfolios across global instruments and major asset classes, including crypto-digital assets, including bitcoin or stable coins. In some implementations of the virtualization engine, a live real-time virtual play leaderboard is provided. In some implementations of the virtualization engine, there is provided the ability to follow other user trades, view their virtual portfolios and deep analysis into their holdings. In some implementations of the virtualization engine, there is provided the ability for user member to create and manage their own virtual private leagues and invite users from within the user community.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a schematic diagram of a digital computing environment in which certain aspects of the present disclosure may be implemented.

FIG. 2 is an illustrative block diagram of workstations and servers that may be used to implement the processes and functions of certain implementations of the present disclosure.

FIG. 3 illustrates a system configured for data processing, in accordance with one or more implementations.

FIG. 4 illustrates a method for data processing, in accordance with one or more implementations.

FIG. 5 is an illustrative functional block diagram of a mobile communications device environment that may be used to implement the processes and functions, in accordance with one or more implementations.

FIG. 6 is an example block diagram of an illustrative user data storage data in accordance with one or more implementations.

FIG. 7 is an example block diagram of an illustrative user media feed environment in accordance with one or more implementations.

FIG. 8 is an example block diagram of an illustrative social interactions environment set in accordance with one or more implementations.

FIG. 9 is an example block diagram of an illustrative virtual portfolio environment in accordance with one or more implementations.

FIG. 10 is an example block diagram of an illustrative system league environment in accordance with one or more implementations.

FIG. 11 is an example block diagram of an illustrative virtual watchlist environment in accordance with one or more implementations.

FIG. 12 is an example block diagram of an illustrative virtual PPAD engine in accordance with one or more implementations.

FIG. 13 is a schematic diagram of a digital computing environment in which certain aspects of the present disclosure may be implemented.

FIG. 14 is an illustrative a digital computing graphics environment in which certain aspects of the present disclosure may be implemented, in accordance with one or more implementations.

FIG. 15 is an illustrative a digital computing graphics environment in which certain aspects of the present disclosure may be in a graphical user interface in accordance with one or more implementations.

FIG. 16 is an illustrative a digital computing graphics environment in which certain aspects of the present disclosure may be in a graphical user interface in accordance with one or more implementations.

FIG. 17 is an illustrative a digital computing graphics environment in which certain aspects of the present disclosure may be in a graphical user interface in accordance with one or more implementations.

FIG. 18 is an illustrative a digital computing graphics environment in which certain aspects of the present disclosure may be in a graphical user interface in accordance with one or more implementations.

FIG. 19 is an illustrative a digital computing graphics in which certain aspects of the present disclosure may be in a graphical user interface in accordance with one or more implementations.

FIG. 20 is an illustrative a digital computing graphics environment in which certain aspects of the present disclosure may be in a graphical user interface in accordance with one or more implementations.

FIG. 21 is an illustrative a digital computing graphics environment in which certain aspects of the present disclosure may be in a graphical user interface in accordance with one or more implementations.

FIG. 22 is an illustrative a digital computing graphics environment in which certain aspects of the present disclosure may be in a graphical user interface in accordance with one or more implementations.

FIG. 23 is an illustrative a digital computing graphics environment in which certain aspects of the present disclosure may be in a graphical user interface in accordance with one or more implementations.

FIG. 24 is an illustrative a digital computing graphics environment in which certain aspects of the present disclosure may be in a graphical user interface in accordance with one or more implementations.

FIG. 25 is an illustrative a digital computing graphics environment in which certain aspects of the present disclosure may be in a graphical user interface in accordance with one or more implementations.

FIG. 26 is an illustrative a digital computing graphics environment in which certain aspects of the present disclosure may be in a graphical user interface in accordance with one or more implementations.

FIG. 27 is an illustrative a digital computing graphics environment in which certain aspects of the present disclosure may be in a graphical user interface in accordance with one or more implementations.

FIG. 28 is an illustrative a digital computing graphics environment in which certain aspects of the present disclosure may be in a graphical user interface in accordance with one or more implementations.

### DETAILED DESCRIPTION

In the following description of the various implementations, reference is made to the accompanying drawings, which form a part hereof, and in which is shown by way of illustration, various implementations in which the disclosure may be practiced. It is to be understood that other implementations may be utilized and structural and functional modifications may be made.

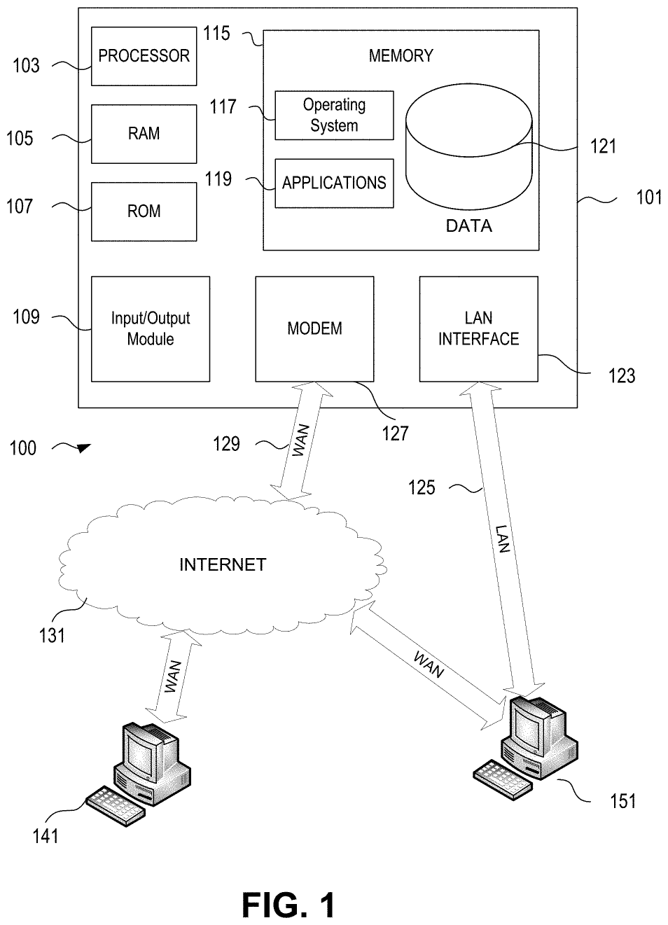

FIG. 1 illustrates a block diagram of a specific programmed computing device 101 (e.g., a computer server) that may be used according to an illustrative implementation of the disclosure. The computer server 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide computer readable instructions to processor 103 for enabling server 101 to perform various technologic functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with vendors and patrons, allowing functional interoperability between different elements located at multiple physical locations.

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various protocols such as TCP/IP, Ethernet, FTP, HTTP and the like is presumed. The network connections may be provided according to any desired encoding and modulating scheme, including Bluetooth, ZIGBEE, Z-Wave, cellular, radio frequency, WIFI, near field communications (NFC) and the like.

Computing device 101 and/or terminals 141 or 151 may also be mobile terminals including various other components, such as a battery, speaker, and antennas (not shown).

The disclosure is operational with numerous other special purpose computing system environments or configurations. Examples of computing systems, environments, and/or configurations that may be suitable for use with the disclosure include, but are not limited to, personal computers, server computers, hand-held or laptop devices, multiprocessor systems, microprocessor-based systems, cloud-based systems, set top boxes, programmable consumer electronics, network PCs, minicomputers, mainframe computers, mobile computing devices, e.g., smart phones, wearable computing devices, tablets, distributed computing environments that include any of the above systems or devices, and the like.

The disclosure may be described in the context of computer-executable instructions, such as program modules, being executed by a computer. Generally, program modules include routines, programs, objects, components, data structures, and sensors that perform particular tasks or implement particular computer data types. The disclosure may also be practiced in distributed computing environments where tasks are performed by remote processing devices that are linked through a communications network. In a distributed computing environment, program modules may be located in both local and remote computer storage media including memory storage devices.

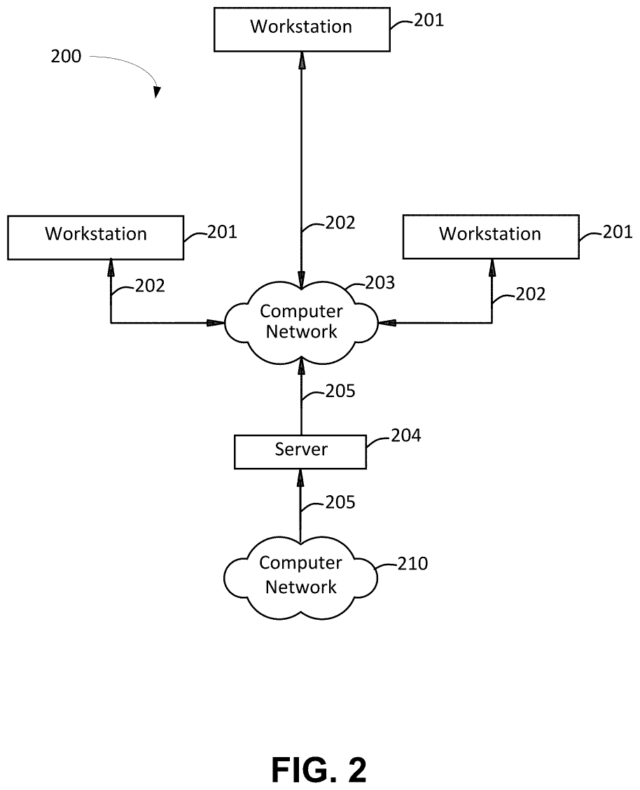

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer networks 203, 210 that is linked via communications links 205 to server 204. In system 200, server 204 may be any suitable server, processor, computer, or data processing device, or combination of the same. Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

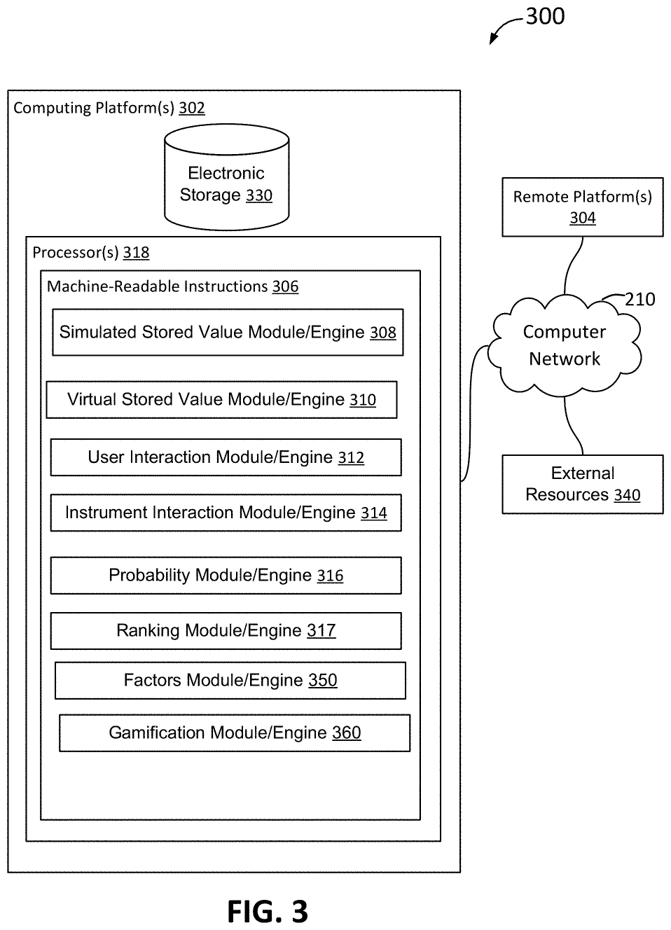

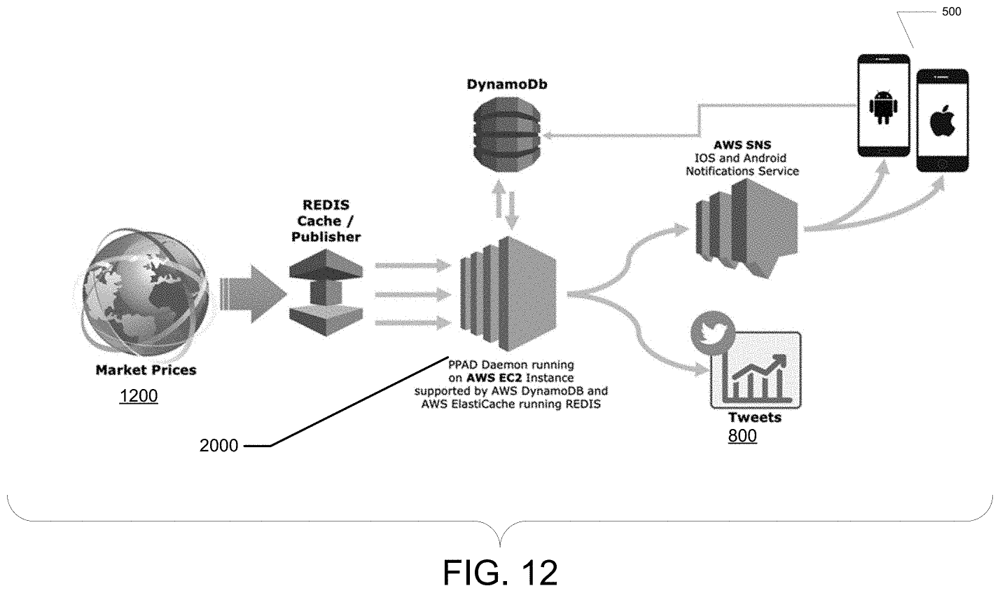

FIG. 3 illustrates a system 300, 300′ configured for data processing, in accordance with one or more implementations. The disclosure may be described in the context of cloud-based computing architecture employing Amazon Web Service (AWS). Nevertheless, other commercially available cloud-based services may be used, such as Microsoft Azure, and Google Cloud. The system 300 API components may be provided in the AWS cloud and have been architected to scale in a resilient manner through the use of technologies chosen without any legacy dependencies. Referring to FIG. 12, in some implementations of the system 300, 300′ and method, main persistent data storage pertains to Amazon DynamoDB—a fully managed proprietary NoSQL database service that supports key-value and document data structures—where content, interaction, profile and other non-financial information is stored. In some implementations of the system 300, 300′ and method, social graph data (i.e. relationships between users) is stored on Amazon Neptune—a fully managed graph database. In some implementations of the system 300, 300′ and method, scalability is supported by multiple Redis (Remote Dictionary Server by Redis Labs) clusters acting as read only in-memory databases. In some implementations of the system 300, 300′ and method, data is warehoused on Amazon Redshift—a cloud data warehouse—and reporting capability is built with Tableau BI toolset. In some implementations of the system 300, 300′ and method, API components (including daemons and engines) are coded in node.js with the exception of Al daemons that are coded with Python (with Google TensorFlow for clustering). In some implementations of the system 300, 300′ and method, some API components are executed on AWS Lambda (serverless computing) allowing highly scalable capacity to respond to user database interactions and system failure/warnings.

In some implementations, system 300, 300′ may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

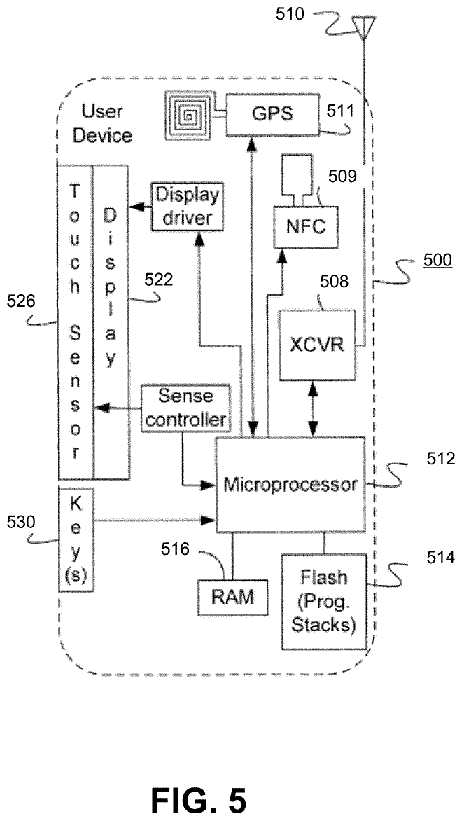

In some implementations of the system 300, 300′ and method, user registration, profile creation and maintenance are provided. In some implementations of the system 300 and method, a security digital database 1200, discovery mechanisms and instrument watchlist maintenance are provided to the user. In some implementations of the system 300 and method, the technology enables synchronization of the instrument database 1200 with multiple brokerage/custody systems 1300. In some implementations of the system 300 and method, the technology enables social graph functionality by allowing discovery and following of other users in the system. In some implementations of the system 300 and method, social functionality enables posting on a media feed 700, the indications of digital assets liking, commenting and sharing posts—via a social graph database that allows for relationship maintenance. In some implementations of the system 300 and method, delivery of event notices to client devices 500 (see FIG. 5) is enabled via a mobile event management component with “Over-The Air” infrastructure technology. In some implementations of the system 300 and method, a two-way external social network interaction can be used to share from the media feed 700 onto other social networks and sharing of external content onto the media feed 700.

Some implementations of the system 300, 300′ and method enable market data delivery of real-time price data to users and delivery of price and position profit/loss alerts to clients as notifications using PPAD engine 2000 (see FIG. 12). In some implementations, delivery of historical market data for charts and technical analysis can be provided to the mobile client 500 (e.g., smart phones, wearable computing devices, tablets).

In some implementations of the system 300, 300′ and method, media content such as news, commentaries, calendars, fundamental data, research and community sentiment 2309 are delivered individually and tailored news, commentaries and research content to one or more of user's feed 700. Users also have the ability to search through all historic news articles and community posts. Some implementations provide an “at-a-glance” Instrument Scores calculated from fundamental instrument data through the system 300. Additionally, real-time gaming user community sentiment 2309 and trading accuracy can be provided to the user on a per instrument basis.

Computing platform(s) 302 may be configured by machine-readable instructions 306. Machine-readable instructions 306 may include one or more instruction modules or engines. The instruction modules may include computer program modules. The instruction modules may include one or more of simulation stored value module (SSVM) 308, Virtual Stored Value Module (VSVM) 310, User Interaction Module (UIM) 312, Instrument Interaction Module (IIM) 314, Probability Module (PrM) 316, Ranking Module (RkM) 317, Factors Module (FaM) 350, a Gamification Module (GaM) 360 and/or other instruction modules.

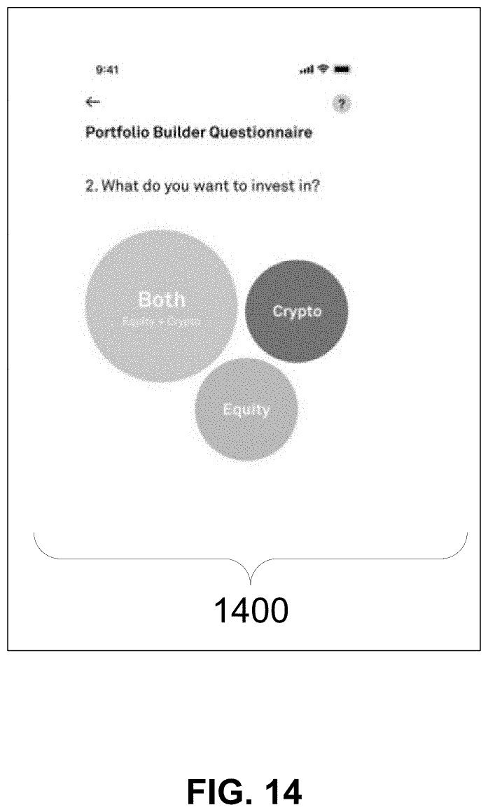

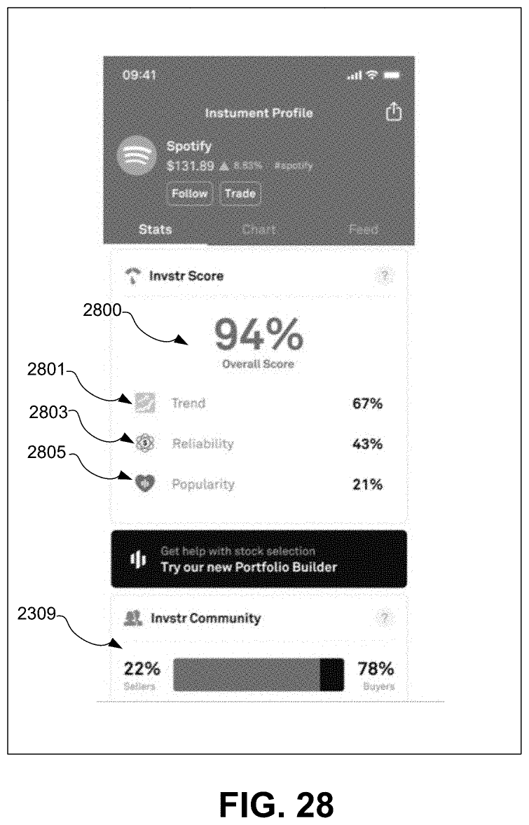

The modules 308, 310, 312, 314, 316, 317, 350, 360 and other modules implement APIs containing functions/sub-routines which can be executed by another software system, such as email and internet access controls. API denotes an Application Programming Interface. The systems and methods of the present disclosure can be implemented in various technological computing environments including Simple Object Access Protocol (SOAP) or in the Representational State Transfer (REST). REST is the software architectural style of the World Wide Web. REST APIs are networked APIs that can be published to allow diverse clients, such as mobile applications, to integrate with the organizations software services and content. Many commonly-used applications work using REST APIs as understood by a person of skill in the art. The computer programs at the system 300 includes appropriate screen routines for generating a set of screens with virtual graphical objects that together comprise one or more graphical user interface implementations as shown in FIGS. 14-28.

With reference to FIG. 3, in some implementations, the “attribute data” including ASCII characters in computer readable form or binary complied data, such as biometric data. The ASCII characters or binary data can be manipulated in the software of system 300. The network 203, 210 can be used for sending data using OSI Open Systems Interconnection (OSI) model, including the transport layer (OSI layer 4). Protocols, such as TCP/IP, may be utilized for transport of data.

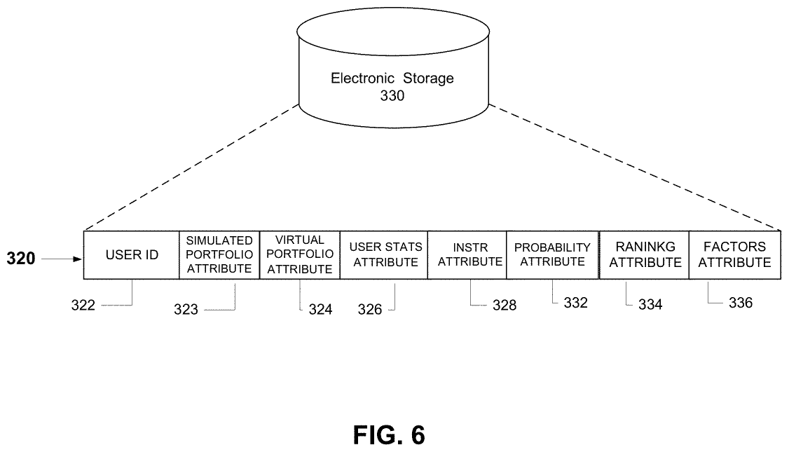

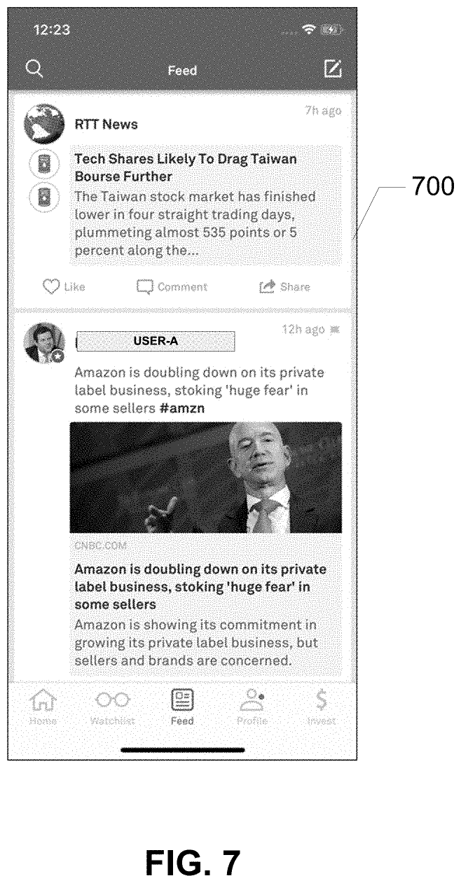

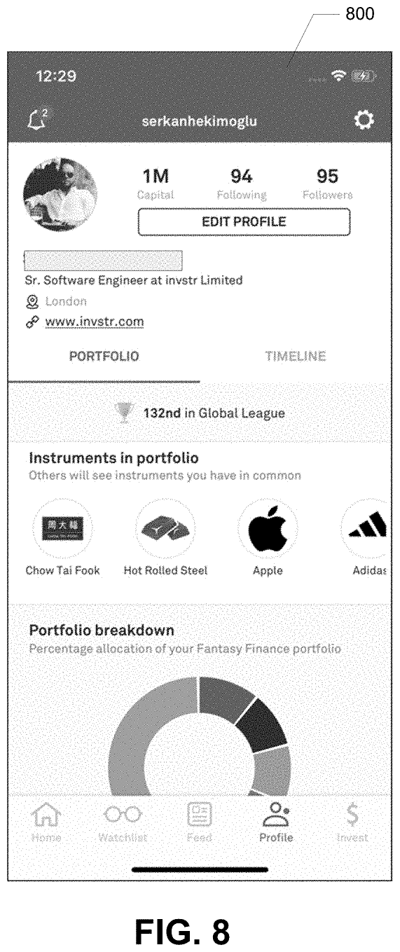

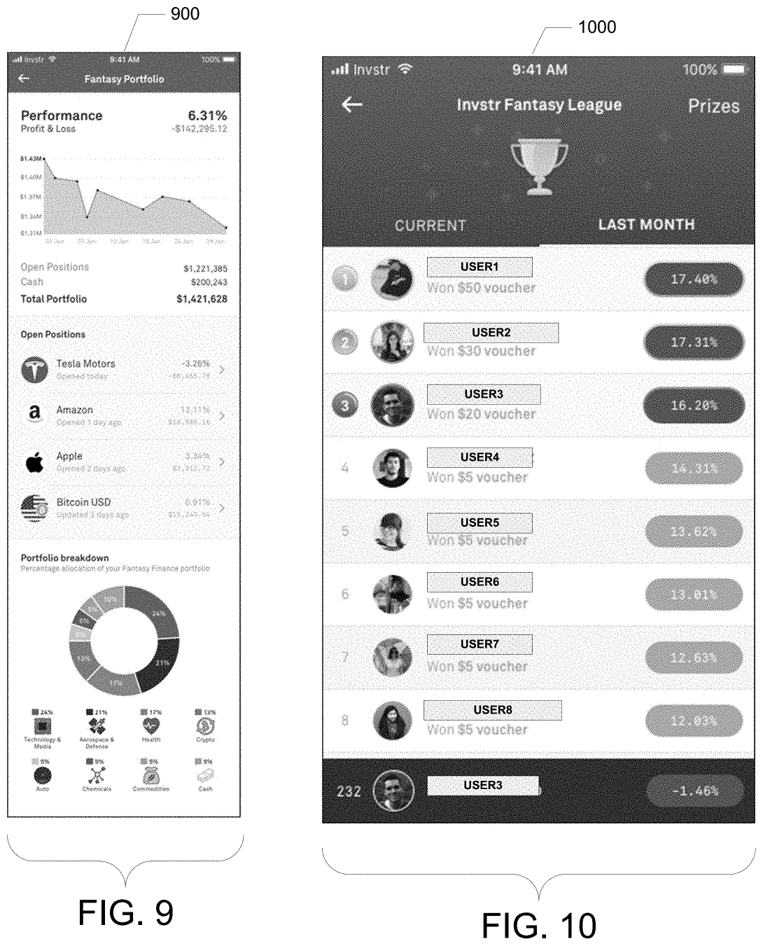

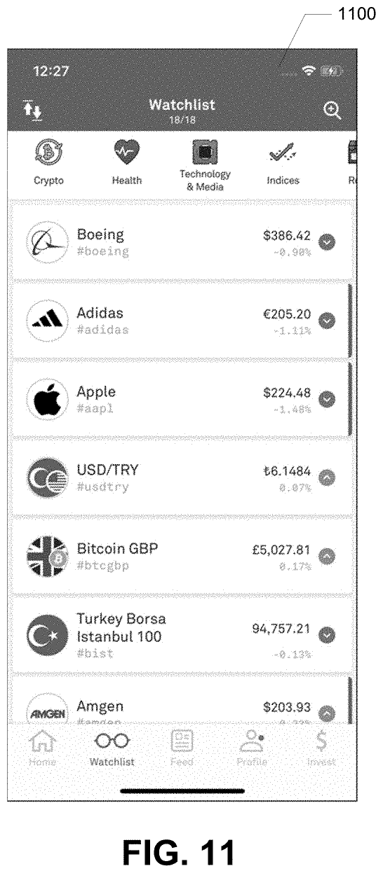

With reference to FIGS. 3-28 modules 308, 310, 312, 314, 316, 317, 350, 360 and other modules implement APIs implements attribute data about a user. In some implementations, the system 300 may employ selective attribute data in the Electronic Data Interchange (EDI) format to form a tokenized data structure for data transfer and/or processing. The attribute data 320 relates to a single user ID 322. The attribute data 323 pertains to simulated portfolio attribute data associated with SSVM module 308. The virtual portfolio analysis may include virtual portfolio attribute data records 324 storage indicative of the user's probability and diversification records, asset class, including equities, digital crypto or combination thereof, sector and geographic data. The virtualization analysis may include the instruments a user has in their watchlist environment 1100 and in their portfolio 900, and what instruments the user buys or sells, including crypto stored value of records, such as blockchain implementations of Bitcoin and other crypto-coins. In one implementation, the methods herein utilize blockchain technology as a dynamic metadata for attribute data to provide a consistent view of the metadata to all the members of the network despite its dynamicity. The most recognizable use case of blockchain is cryptocurrencies such as Bitcoin where the blockchain is used to maintain a ledger of all the transactions and to prevent the double spending. The methods herein can be efficiently translated to what is acceptable by current blockchains such as Bitcoin and Ethereum. The network system 300 herein can leverage the blockchain as a distributed data structure to maintain and augment the metadata without relying on any trusted third party by way of the ledger. In some implementations virtual portfolio attribute data records 324 pertains to real-time store of value monetary assets for brokerage accounts 1300, such as asset class, including equities, digital crypto or combination thereof, sector and geographic data.

### VSVM Module

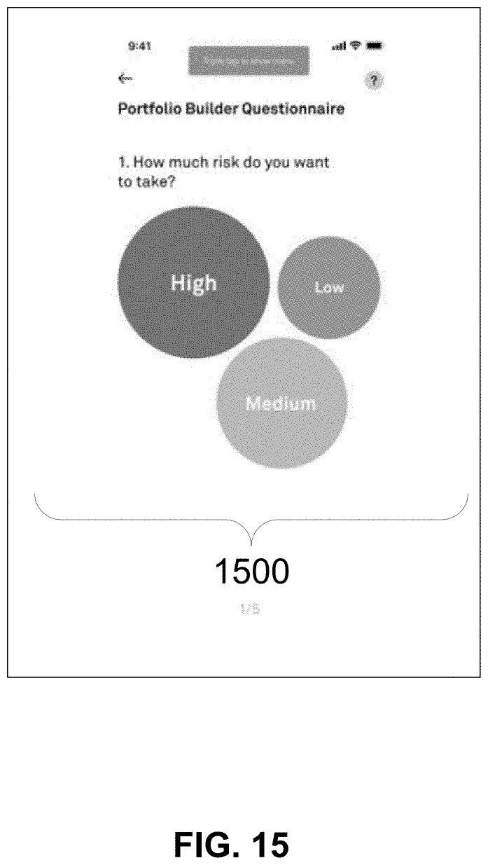

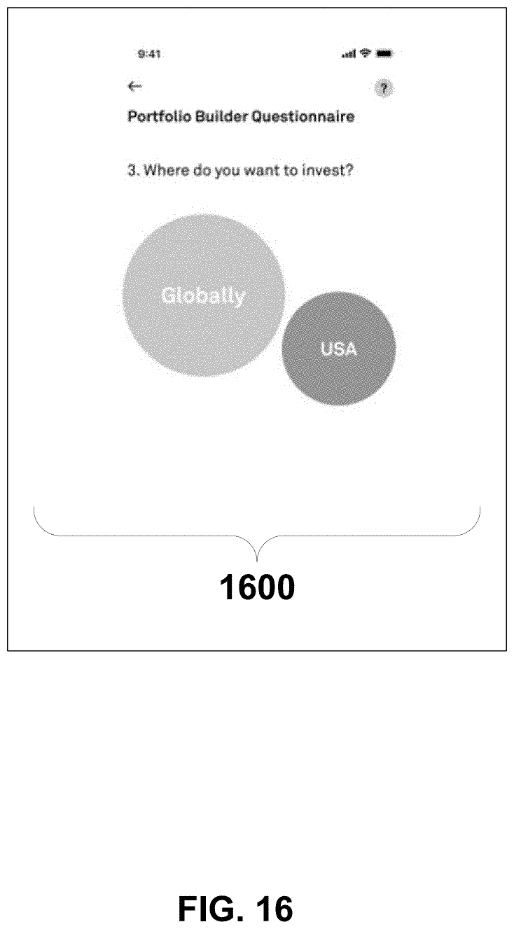

Referring to FIGS. 3, 6, 14-19 in the VSVM module 310 may enable a virtual portfolio management tool with a watchlist environment 1100 with watchlist attribute data, securities and individuals compete in a global digital virtual fantasy league environment 1000 with user league attribute data. VSVM module 310 executes data and brings together the features of User Interaction module 312 and Instrument Interaction module 314 to help identify optimized virtual portfolios attribute data 324 of instruments based on a user's selective inputs associated with user id 322 and the underlying characteristics of instruments as calculated by system 300. In one implementation shown in FIGS. 14-18, the user id 322 has associated data for answering a questionnaire with one or more input data questions with user selectable (“clickable”) graphical objects for a system algorithm with multivariable equations. One input data and associated graphical object may include preferred assets data 1400 to select from a group including equities, crypto currencies, or a combination of both (see FIG. 14). Another input data and associated graphical object may include risk profile data 1500 selected from a group including low, medium or high (See FIG. 15). Another input data and associated graphical object may include for equities geographical preferences data 1600 selected from a group including the Americas or global (See FIG. 16).

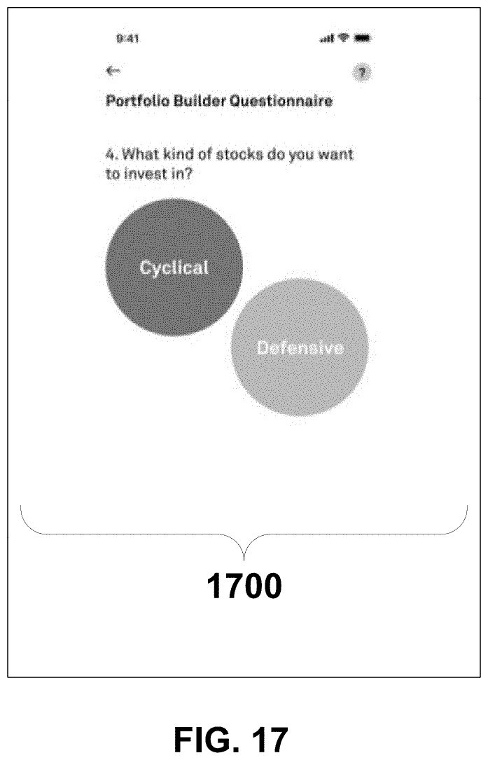

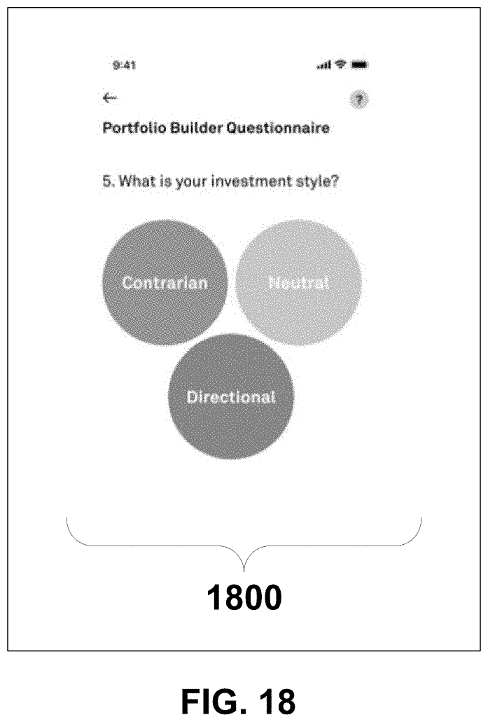

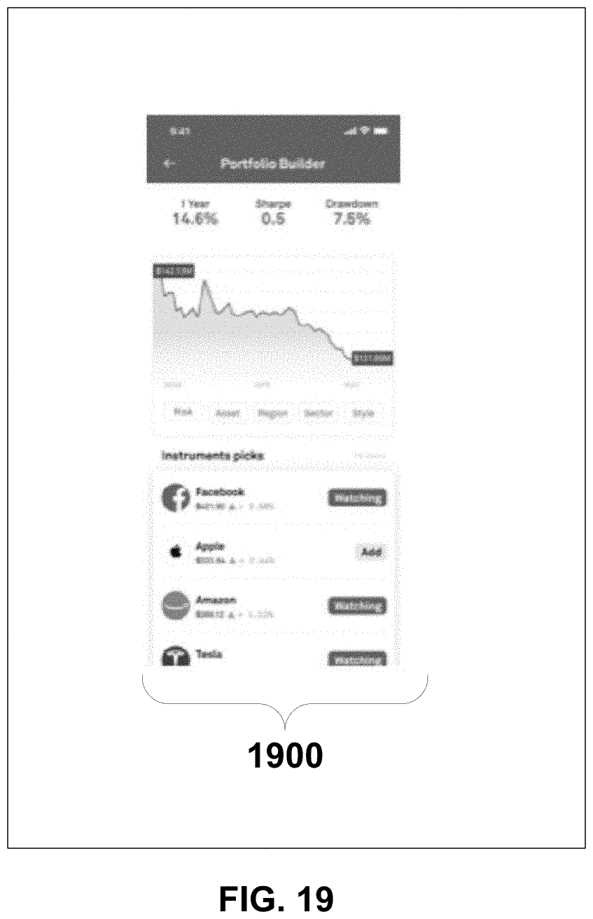

In one implementation, the GPS interface 511 can detect location of device 500 to create GPS attribute data location to provide input. Another input data 1700 and associated graphical object may include for equities may include cyclical or defensive sectors (see FIG. 17). Another input data 1800 and associated graphical object may include for equities trend or contrarian style data. (See FIG. 18) Referring to FIG. 19 then VSVM module 310 generates virtual portfolio 1900 with attribute data 324 and configured for the user id 322 that may be backtested for the last 12 months based on a series of multivariable equations and calculations. In some implementations, VSVM module 310 may incorporate various machine intelligence (MI) neutral network 340 features of available Tensorflow or Neuroph software development platforms (which are incorporated by reference herein) to generate virtual portfolio attribute data 324. In some implementations, VSVM 310 may be software system implementing an API containing functions/sub-routines electronically processing and functioning with the virtual portfolio attribute data records 324. VSVM 310 may implement for learned user behavior within system 300 for the input data components 1400, 1500, 1600, 1700, 1800 observed within the system, in order to automate generation of virtual portfolio 1900 of stored value.

### User Interaction and Ranking Module

With reference to FIGS. 3, 6, 12, and 20-22 user interaction module 312 implements user stats attribute data 326 about one or more of fitness, practice and performance rankings with system 300 and ranking module 317. These rankings may be generally ordinal numbers and may be performed relative to the virtual digital badge level of the user, such as virtual trophies. In some implementations, module 312 includes processing digital trophies - awards by the technology platform 300 in recognition of the user's progress or achievements across a variety of potential interactions. In some implementations of module 317, fitness ranking measures the effort that a user is putting into reading news, following the markets, using charts and leveraging the social aspects of the community (see FIG. 12). Regarding fitness ranking, ranking module 317 also processes a user's social media interaction data 800 within the system 300 and external networks. The social media interaction analysis may include social attribute records storage of who a user is following; who is following that user; the posts, likes, comments, internal and external shares that a user makes; which private leagues a user is in and who the other members of those private leagues 1000 are in the system 300. In some implementations, practice rank measures the level of a user's fantasy activity in gamification module 360. In some implementations, performance rank measures the growth in the user's portfolio 324. User interaction module 312 may be software system implementing an API containing functions/sub-routines.

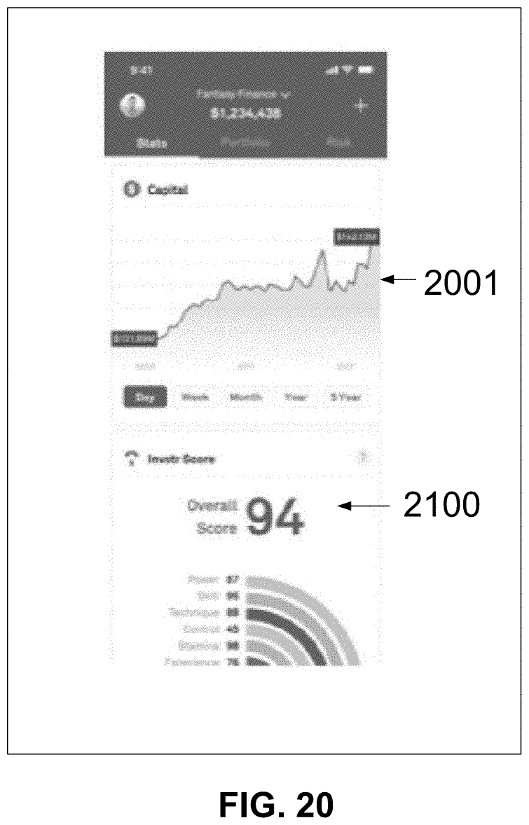

In some implementations shown in FIG. 20, user interaction module 312 also processes capital performance data 2001 over time that enables a user id attribute data 322 to analyze current portfolio attribute data 324 by one or more component inputs, such as industry sector, market capitalization, geography, long vs short and factor style and to see the instruments within their portfolio grouped into the relevant data buckets. In one implementation, a capital chart 2001 allows users to review their capital performance over time in virtual portfolio attribute data 324.

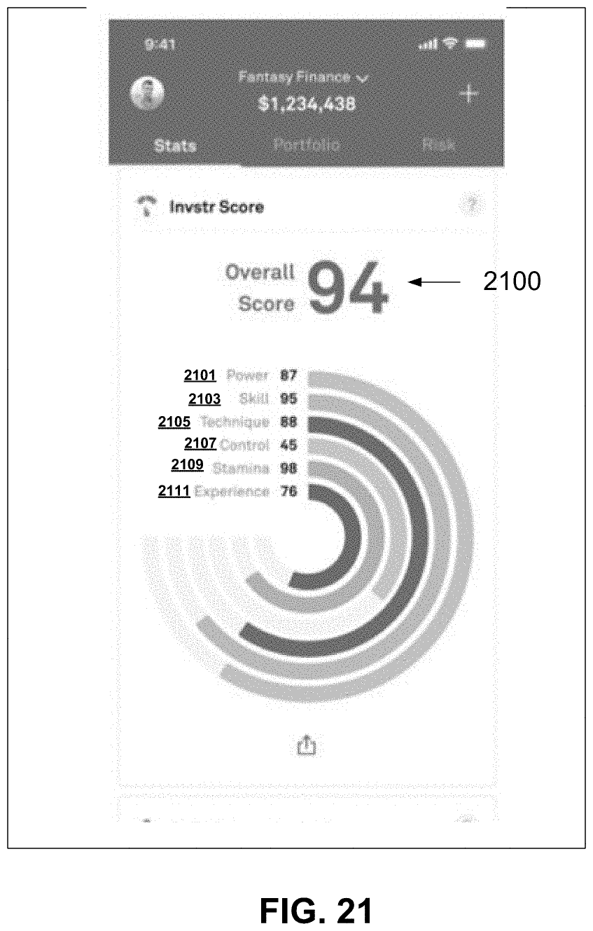

In some implementations referring to FIG. 21, user interaction module 312 electronically generates a user digital score attribute (UDSA) data 2100 executed with multivariable equations using selective digital data input components interacting with virtual portfolio attribute data 324 for a specific user id data record 322. One data component for the multivariable equations may include experience attribute data 2111, such as the diversity of instruments the user id attribute data 322 invest in and how many times they have traded. Another data input component for the multivariable equations may include power attribute data, 2101 such as the growth of the user id data 322 portfolio. Another data input component may include skill attribute data 2103 such as the quality of user id data 322 returns based on how much probabilistic risk measure by beta the user id data 322 elected to achieve the returns (in generally the less risk taken to achieve the returns, the higher the quality of the returns and the higher user skill attribute data score). Another data input component for the multivariable equations may include stamina attribute data 2109 as such, the average holding period (in days) that the user id data 322 held an open position—that is, the longer assets is held, the higher the stamina score. Another data input component for the multivariable equations may include technique attribute data 2105, such as the user id data 322 tendency to make or lose visualizations of stored value on a daily basis.

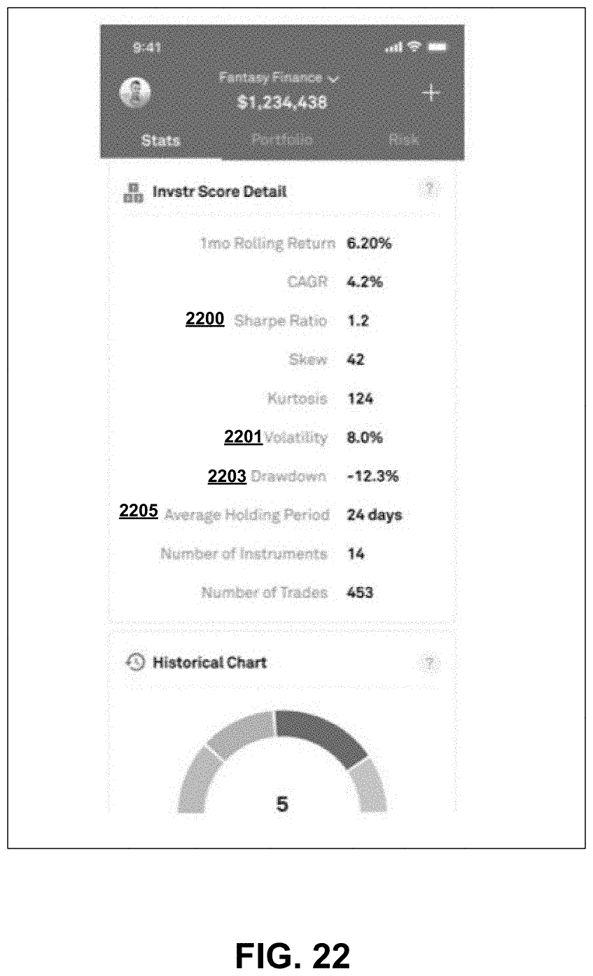

Another data input component for the multivariable equations may include control attribute data 2107, such as user id data 322 ability to avoid large swings in portfolio value 324. In this way users of system 300 can learn organically that investing is about generating a consistent return on capital over time as well as employing diversification concepts without excessive trading. In some implementations referring to FIGS. 21 and 22, digital score attribute data 2100 may provide a detailed breakdown of user id data 322 portfolio returns, Sharpe Ratio data 2200, technique data 2105, control data 2107, volatility data 2201, drawdown data 2203, and average holding period data 2205.

### Instrument Interaction Module

With reference to FIGS. 3, 6 and 23-26, Instrument interaction module 314 processes instrument attribute data 328 for providing one or more features illustrated with emojis, a natural language description of its statistical attributes and a historical price chart. In some implementations, instrument interaction module 314 electronically generates an instrument digital score attribute (IDSA) data 2800 from multivariable equations processed with one or more data input components interacting instrument attribute data 328. One data component may include ranks of stocks and other instruments against similar financial assets using a number of measures generated within system 300. One data component may include, system 300 ranking technology stocks against other technology stocks and retail stocks against other retail stocks. One data component may include trend data 2803 which measures momentum in price and, in the case of a company, earnings. Another data component may include reliability attribute data 2805 which reflects a number of selective underlying factors in an instrument including its stability of returns, value, income and, in the case of a company, profitability. Another data component may include a popularity attribute data 2807 combines what the system 300 user community sentiment data 2309 from gamification module 360 and, in the case of a company, third party databases analysts rating about an instrument. Instrument interaction module 314 may be software system implementing an API containing functions/sub-routines.

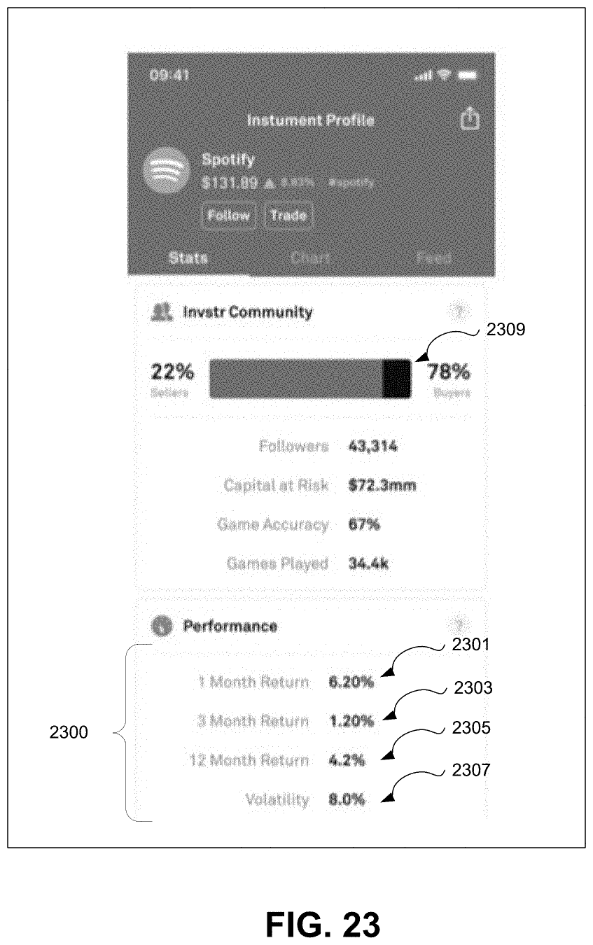

Referring to FIG. 23, some implementations of Instrument interaction module 314 senses and receives community sentiment attribute data 2309 of the user community. Sentiment data 2309 is based on the actions of people employing the gamification module 360. Some implementations of Instrument interaction module 314 electronically processes performance returns attribute data 2300 which reflect the historic price performance of a marked-to-market instrument from market database 1200 over a period of time such as one-month data 2301, three-month data 2303, and/or twelve-months data 2305. Some implementations of Instrument interaction module 314 electronically processes volatility attribute data 2307 of an instrument's price. Some implementations of Instrument interaction module 314 processes Sharpe ratio attribute data 2200 which measures the return of an instrument divided by the volatility of its returns. Some implementations of Instrument interaction module 314 processes drawdown attribute data 2203 which pertains to the most value that an instrument has declined in stored value in any given month processed with PPAD engine 2000.

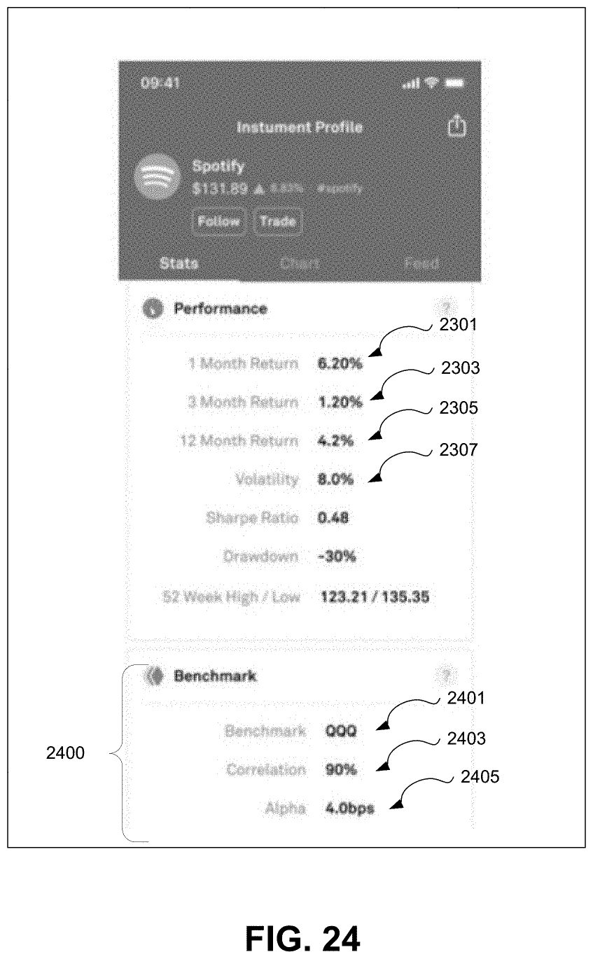

Referring to FIG. 24, some implementations of Instrument interaction module 314 processes benchmark attribute data 2400 which is the index, or ETF, which this instrument most closely follows. In one example, Amazon stock benchmark attribute data pertaining index may be the S&P 500 or the QQQ Powershares ETF 2401. Benchmark attribute data 2400 may include correlation attribute date defined as the degree to which the price of this instrument and its benchmark track each other. Benchmark attribute data may include alpha attribute data 2405 defined as the extent to which this instrument generates a better or worse return than the Benchmark. Benchmark attribute data 2400 may include beta attribute data defined as the amount by which the price of this instrument moves relative to its Benchmark.

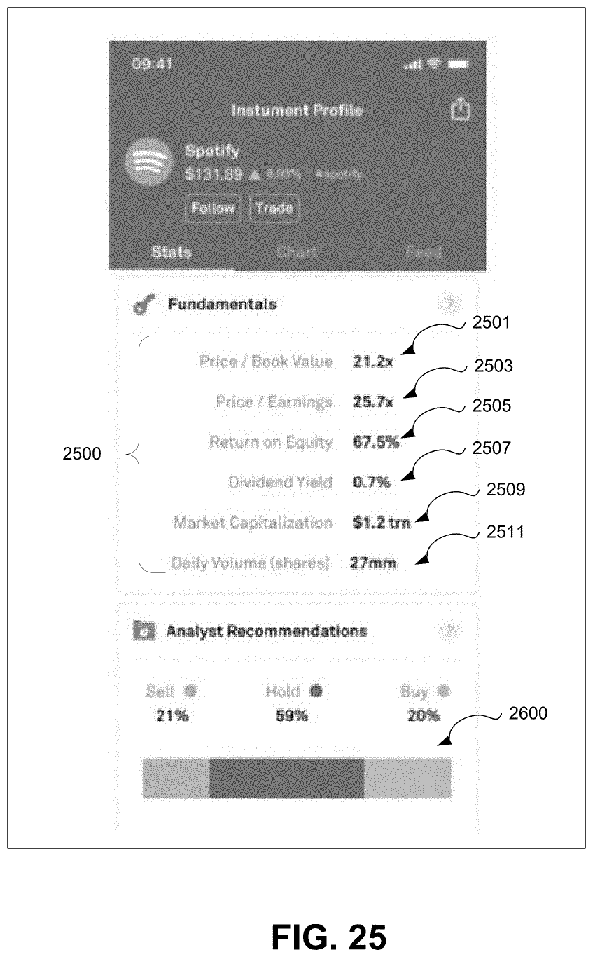

Some implementations of Instrument interaction module 314 shown in FIG. 25 electronically receives or process as what can be characterize as fundamentals attribute data 2500. Fundamentals attribute data may include price-to-book value data 2501 which is the market price (from market database 1200) of a company's stock divided by the net asset value of the company per share. It is noted that the lower the Price-to-book value, the cheaper the company is theoretically. Fundamentals attribute data 2500 may include price-to-earnings data 2503 which is the market price of a company's stock divided by the earnings of the company per share. It should be noted that the lower the price-to-earnings ratio, the cheaper the company is theoretically. Fundamentals attribute data 2500 may include return-on-equity data 2505 which is the net income of a company divided by the value of its equity. It should be noted that the higher the absolute value of return-on-equity data, the more money a company is able to make from its equity. Fundamentals attribute data 2500 may include dividend yield data 2507 which is the dividend a company pays per share divided by the price of a company's stock. It should be noted that the higher the Dividend Yield, the more attractive a company may be for passive income generation. Fundamentals attribute data 2500 may include market capitalization data 2509 which is the total value of all the outstanding shares of a company. It should be noted that market capitalization data 2509 is an indication of the value that the market places on a company. Fundamentals attribute data 2500 may include daily trading volume data 2511 which the average number of a company's shares that are traded each day.

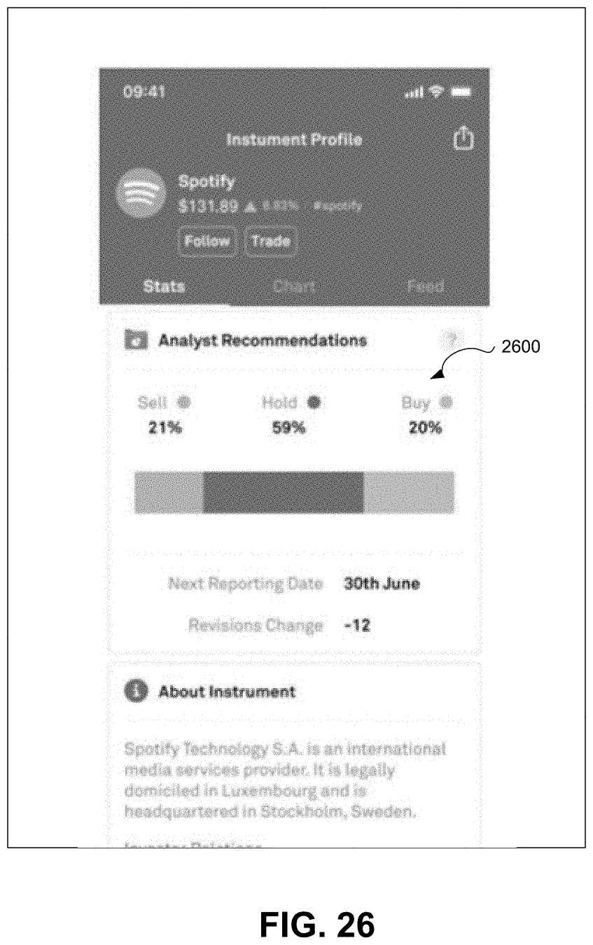

Referring to FIGS. 25 and 26, some implementations of Instrument interaction module 314 may include a data analyst recommendation attribute data 2600 which reflect the views of analysts who follow and write research reports on a company's stock. ‘Buy’ reflects a positive outlook for the company's share price ‘Hold’ reflects a neutral outlook for the company's stock price ‘Sell’ reflects a negative outlook for the company's stock price.

### Factors Module

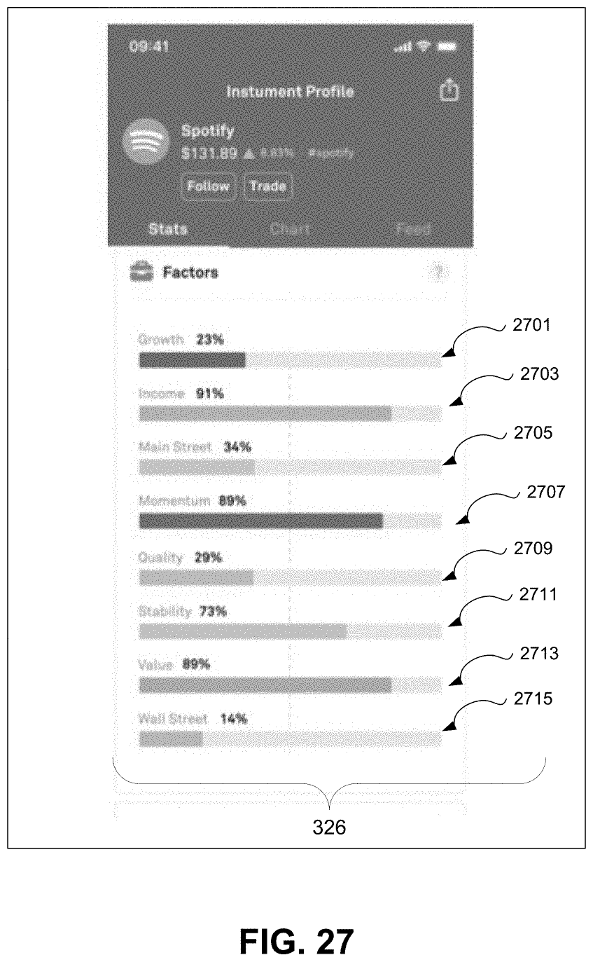

Referring to FIG. 27, Factors module 350 electronically processes factors attribute data 326 for ranking company or instrument against its peer group or sector one or more following factor input data. One factor data component may include growth attribute data 2701 which is growth in a company's revenues and earnings. One data component for FaM 350 may include income attribute data 2703 which is the dividend rate or rate of interest a company pays. One data component for FaM 350 may include third-party community attribute sentiment data 2705 for an instrument. One data component for FaM 350 may include momentum attribute data 2707 which is the momentum in an instrument's price. One data component for FaM 350 may include quality attribute data 2709 which a company's return on equity or profitability. One data component for FaM 350 may include stability attribute data 2711 which is the consistency of returns in an instrument. One data component for FaM 350 may include value attribute data 2713 which is how cheap or expensive a stock is relative to its peer group. One data component for FaM 350 may include market analysts attribute data 2715 which may include analyst earnings database forecasts and recommendations for a stock.

### Gamification Module

In some implementations, the system 300 gamification module 360 enables users to create and manage their own private virtual leagues 1000 and invite their friends, colleagues and classmates to compete against them. In some implementations, a group chat functions enables the members of a virtual private league to communicate among themselves. They can further collaborate in these private leagues with the user of group chat messaging. In this way, user can learn about investing in a risk free-way. Gamification module 360 may be software system implementing an API containing functions/sub-routines.

In some implementations, the system 300 probability module 316 process data with probability attribute data 328 which may include risk management parameter.

Referring to FIG. 12, in some implementations, system 300 with module 310 employs Price and Portfolio Position Profit Alert Engine 2000 that is tasked to send alerts (in the form of mobile device notifications) to users regarding significant changes in security prices and large shifts in Profit and Loss positions of predictions made by the users (in virtual with gamification module 360). In some implementations, the system 300 draws a chart and posts it to the media feed 700 (e.g., #invstream) as a tweet if an instrument's latest price exceeds 52 weeks' low/high.

In some implementations, computing platform(s) 302, remote platform(s) 304, and/or external resources 340 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 340 may be operatively linked via some other communication media.

A given remote platform 304 may include one or more processors configured to execute computer program modules. The computer program modules may be configured to enable an expert or user associated with the given remote platform 304 to interface with system 300 and/or external resources 340, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 340 may include sources of information outside of system 300, external entities participating with system 300, and/or other resources. In some implementations, some or all of the functionality attributed herein to external resources 340 may be provided by resources included in system 300.

Computing platform(s) 302 may include electronic storage 330, one or more processors 318, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 330 may comprise non-transitory storage media that electronically stores information. The electronic storage media of electronic storage 330 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 330 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 330 may include one or more virtual storage resources (e.g., cloud storage, a virtual private network, and/or other virtual storage resources). Electronic storage 330 may store software algorithms, information determined by processor(s) 318, information received from computing platform(s) 302, information received from remote platform(s) 304, and/or other information that enables computing platform(s) 302 to function as described herein.

Processor(s) 318 may be configured to provide information processing capabilities in computing platform(s) 302. As such, processor(s) 318 may include one or more digital processors, an analog processor, a digital circuit designed to process information, an analog circuit designed to process information, a state machine, and/or other mechanisms for electronically processing information. Although processor(s) 318 is shown in FIG. 3 as a single entity, this is for illustrative purposes only. In some implementations, processor(s) 318 may include a plurality of processing units. These processing units may be physically located within the same device, or processor(s) 318 may represent processing functionality of a plurality of devices operating in coordination. Processor(s) 318 may be configured to execute modules 308, 310, 312, 314, 316, 317, 350, 360 and/or other modules. Processor(s) 318 may be configured to execute modules 308, 310, 312, 314, 316 and/or 317, 350, 360, and/or other modules by software; hardware; firmware; some combination of software, hardware, and/or firmware; and/or other mechanisms for configuring processing capabilities on processor(s) 318. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, 316, 317, 350 and 360 are illustrated in FIG. 3 as being implemented within a single processing unit, in implementations in which processor(s) 318 includes multiple processing units, one or more of modules 308, 310, 312, 314, 316 and/or 317, 350, 360 may be implemented remotely from the other modules. The description of the functionality provided by the different modules 308, 310, 312, 314, 316, 317, 350, and/or 360 described below is for illustrative purposes, and is not intended to be limiting, as any of modules 308, 310, 312, 314, 316 and/or 317, 350, 360 may provide more or less functionality than is described. For example, one or more of modules 308, 310, 312, 314, 316, 317, 350, and/or 360 may be eliminated, and some or all of its functionality may be provided by other ones of modules 308, 310, 312, 314, 316, 317, 350, and/or 360. As another example, processor(s) 318 may be configured to execute one or more additional modules that may perform some or all of the functionality attributed below to one of modules 308, 310, 312, 314, 316, 317, 350, and/or 360.

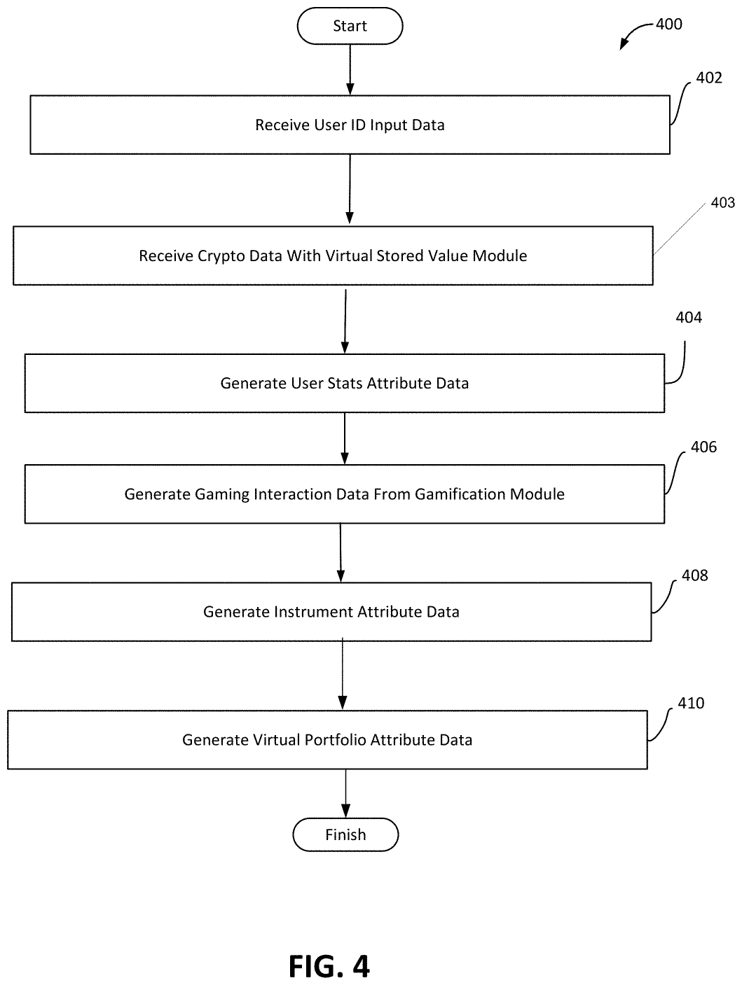

FIG. 4 illustrates a method 400 for data processing, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

FIG. 4 illustrates method 400, in accordance with one or more implementations. An operation 402 may include receiving the user id data 322 from a computer readable set of user data records. Operation 402 may be performed by one or more hardware processors configured by machine-readable instructions including a module that is the same as or similar to module 308, in accordance with one or more implementations.

An operation 403 may include electronically processing the computer readable set of user data records to receive input data and associated graphical object may include preferred assets data 1400 to select from a group including equities, crypto currencies, including stable coin or a combination of both (see FIG. 14). Another input data and associated graphical object may include risk profile data 1500 selected from a group including low, medium or high (See FIG. 15). Another input data and associated graphical object may include for equities geographical preferences data 1600 selected from a group including the Americas or global (See FIG. 16). Another input data 1700 and associated graphical object may include for equities may include cyclical or defensive sectors (see FIG. 16). Another input data 1800 and associated graphical object may include for equities trend or contrarian style data. (See FIG. 18). Operation 403 may be performed by one or more hardware processors configured by machine-readable instructions including a module that is the same as or similar to module 310, in accordance with one or more implementations.

An operation 404 may include electronically processing the computer readable set of user data records for generating user stats attribute data 360. Operation 404 may be performed by one or more hardware processors configured by machine-readable instructions including a module that is the same as or similar to module 312, in accordance with one or more implementations.

An operation 406 may include electronically processing the computer readable set of user data records to generate gaming interaction data. Operation 406 may be performed by one or more hardware processors configured by machine-readable instructions including a module that is the same as or similar to module 350, in accordance with one or more implementations.

An operation 408 may include electronically processing computer readable instrument attribute data 328. Operation 408 may be performed by one or more hardware processors configured by machine-readable instructions including a module that is the same as or similar to module 308, in accordance with one or more implementations.

An operation 410 may include generating a computer readable virtual portfolio data 324. Operation 410 may be performed by one or more hardware processors configured by machine-readable instructions including a module that is the same as or similar to module 308, in accordance with one or more implementations.

FIG. 5 provides a block diagram illustration of an exemplary user device 500 that can implement digital display environments and other features. Although the user device 500 may be a smart-phone, a tablet, or another type of device, the illustration shows the user 500 is in the form of a handset (although many components of the handset, such as a microphone and speaker, are not shown).

Referring to FIG. 5 for digital wireless communications, the user device 500 includes at least one digital transceiver (XCVR) 508 connected to an antenna 510 that receives data packets uploads and downloads using cell tower transmissions with an information alert (e.g., push notification) from an Over-The-Air Transmitter. The transceiver 508 provides two-way wireless communication of information, such as digital information, in accordance with the technology of the network. The transceiver 508 also sends and receives a variety of signaling messages in support of the various services provided via the user device 500 and the communication network. The user device 500 also includes an NFC interface 509 having an associated antenna and configured for communicating using near-field communication with other devices such as with an NFC reader. The user device 500 includes a display 522 for displaying messages, menus, graphical user interfaces shown in FIGS. 14-28 or the like, user related information for the user, etc. A touch sensor 526 and keypad 530 enables the user to generate selection inputs, for example.

A microprocessor 512 serves as a programmable controller for the user device 500, in that it controls all operations of the user device 500 in accord with programming that it executes, for all normal operations, and for operations involved in the real-time trading guidance in system 300. In the example, the user device 500 includes flash type program memory 514, for storage of various program routines and configuration settings. The user device 500 may also include a non-volatile random access memory (RAM) 516 for a working data processing memory. In a present implementation, the flash type program memory 514 stores any of a wide variety of applications, such as navigation application software and/or modules. The memories 514, 516 also store various data, such as input by the user. Programming stored in the flash type program memory 514 is loaded into and executed by the microprocessor 512 to configure the processor 512 to perform various desired functions, including functions involved in push notification processing.

In some examples, the user device 500 further includes a GPS interface 511 coupled to a GPS antenna designed to receive GPS location signals transmitted by satellites. The GPS interface 511 is communicatively coupled to the microprocessor 512, and is operative to provide location information to the microprocessor based on the received location signals.

In one construction, a biometric device system located in Device 500 may be included to enable for securely storing in the device biometric data unique to the user. The electronic biometric data can be maintained, or otherwise stored within a memory/database, such as memory 514 and/or RAM 105 as shown in FIG. 1 in which memory in located within the device (e.g., smart phones).

Aspects of the present disclosure provide a rich user experience by integrating one or more of personalized content, virtualization of the financial markets, social features and ecommerce capabilities in a single user experience.

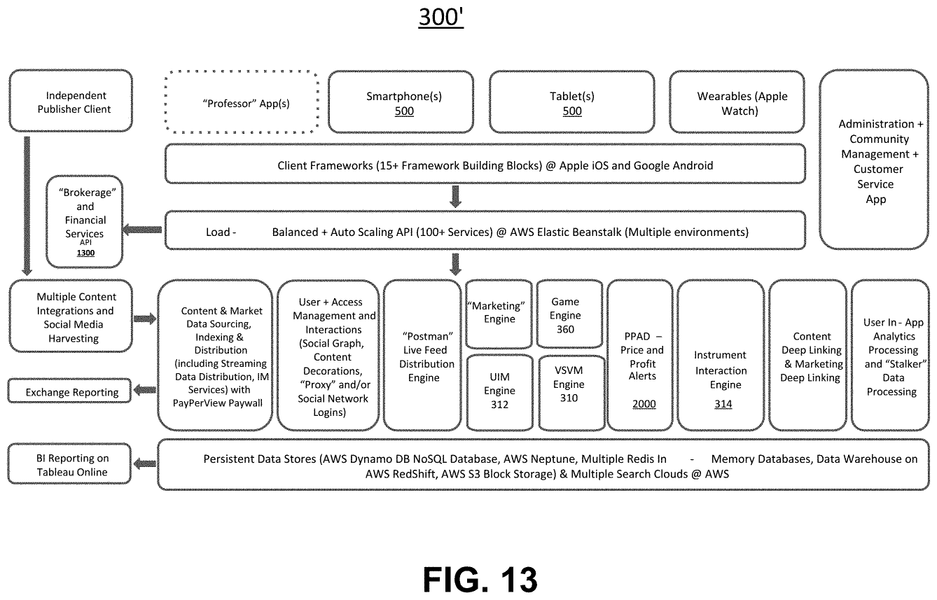

FIG. 13 illustrates a schematic diagram of a digital computing environment 300′ in which certain aspects of the present disclosure may be implemented. In some implementations, modules 308, 310, 312, 314, 316 and 317, 350, 360 as discussed are used in environment 300′. In some implementations, there is provided a portfolio page displaying the client's investment portfolio and the historical performance of the portfolio. In some implementations, there is provided a watchlist displaying the financial instruments that the client is following. In some implementations, there is provided a section where the client can discover new instruments to follow or invest in. In some implementations, there is provided an Instrument Hub where the client can see fundamental data for each financial instrument; community sentiment 2309; historical, comparison and technical charting; and a dedicated news feed including news articles, research reports and events calendar for each financial instrument. In some implementations, there is provided a ‘Trade screen’ where a client can execute transactions. In some implementations, there is provided a Leaderboard page where the client can find the top performers within the community. In some implementations, there is provided a track record function - an analysis of a client's portfolio describing her performance; implicit investment mandate; investment style based on financial factor analysis; behavioral analysis of a user's investment transaction history; a measure of a user's success in timing the entry and exit of their investment decisions. In some implementations, there is provided the ability for a user to open bank and brokerage accounts 1300 and spend their funds using a connected debit card or invest her money across a broad range of financial assets, including crypto currencies.

Systems 300 and 300′ makes possible the empowerment of the individual using technology. While the present technology has been described for the purpose of illustration based on what is currently considered to be the most practical and preferred implementations, aspects of the present disclosure could be applied to numerous other industry verticals wherever technology platforms or service providers seek to create maximum client engagement, personalization and suitability.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A computer implemented method of cloud data computing with computer readable instructions, comprising:
electronically processing a computer readable set of user attribute data;
electronically receiving a data token including at least one of the user attribute data;
electronically generating a user digital score attribute data associated with the at least one of the user attribute data;
electronically generating data for a graphical user interface for displaying an instrument digital score attribute data including gaming interaction data associated with the computer readable set of user attribute data; and
electronically generating data for a graphical user interface for displaying a virtual portfolio attribute data associated with the user digital score attribute data and the instrument digital score attribute data.

2. The method of claim 1, further comprising electronically processing the computer readable set of user attribute data to generate social interaction data for generating in the user digital score attribute data.

3. The method of claim 1, wherein the gaming interaction data includes a plurality of user league gaming attribute data.

4. The method of claim 1, wherein the user digital score attribute data is generated from a stamina attribute data, a power attribute data, and a control attribute data.

5. The method of claim 1, wherein the at least one user attribute data further comprises blockchain associated data.

6. The method of claim 5, wherein the blockchain associated data further comprises bitcoin.

7. The method of claim 1, wherein the gaming interaction data comprising gaming community attribute data.

8. The method of claim 1, wherein the at least one of the user attribute data further comprises social media ranking data.

9. The method of claim 1, wherein the at least one of the user attribute data further comprises geographic attribute data.

10. A system configured for data processing, the system comprising:
one or more hardware processors configured by machine-readable instructions to:
electronically processing a computer readable set of user attribute data;
electronically receiving at least one of the user attribute data;
electronically generating a user digital score attribute data associated with the at least one of the user attribute data;
electronically generating data for a graphical user interface for displaying an instrument digital score attribute data including gaming interaction data associated with the computer readable set of user attribute data; and
electronically generating data for a graphical user interface for displaying a virtual portfolio attribute data associated with the user digital score attribute data and the instrument digital score attribute records.

11. The system of claim 10, wherein the one or more hardware processors are further configured by machine-readable instructions to electronically process the computer readable set of user attribute data to generate social interaction data.

12. The system of claim 10, wherein the gaming interaction data includes user league gaming attribute data.

13. The system of claim 10, wherein the user digital score attribute data is generated from a stamina attribute data, a power attribute data, and a control attribute data.

14. The system of claim 10, further comprising electronically processing the computer readable set of user data records to generate gaming interaction data.

15. The system of claim 10, wherein the at least one user attribute data further comprises blockchain associated data.

16. The system of claim 15, wherein the blockchain associated data comprises Bitcoin.

17. The system of claim 10, wherein the at least one of the user attribute data further comprises geographic attribute data.

18. A computing platform configured for data processing, the computing platform comprising:
a non-transient computer-readable storage medium having executable instructions embodied thereon; and
one or more hardware processors configured to execute the instructions to:
electronically process computer readable set of user attribute data;
electronically receive a data token of at least one of the user attribute data;
electronically generating a user digital score attribute data associated with the at least one of the user attribute data;
electronically generate data for a graphical user interface for displaying an instrument digital score attribute data including gaming interaction data associated with the computer readable set of user attribute data; and
electronically generate data for a graphical user interface for displaying a virtual portfolio attribute data associated with the user digital score attribute data and the instrument digital score attribute records.

19. The computing platform of claim 18, wherein the one or more hardware processors are further configured by instructions wherein the user digital score attribute data is generated from a stamina attribute data, a skill attribute data, and a control attribute data.

20. The computing platform of claim 18, wherein the one or more hardware processors are further configured by instructions wherein the gaming interaction data includes user league gaming attribute data.
